(19) United States
(12) Patent Application Publication
(10) Pub. No.: US 2006/0046116 A1
(43) Pub. Date: Mar. 2, 2006

(54) Series type air supply system for fuel cell-powered vehicles

(75) Inventors: Kyoung-Doug Min, Seoul (KR); Han-Sang Kim, Yongin-si (KR); Jung-Hwan Bang, Gimhae-si (KR); Dong-Hun Lee, Anyang-si (KR); Sang-Yeoul Ahn, Seoul (KR); Byung-Ki Ahn, Suwon-si (KR)

Correspondence Address: GREENBLUM & BERNSTEIN, P.L.C., 1950 ROLAND CLARKE PLACE, RESTON, VA, 20191, US

(73) Assignees: HYUNDAI MOBIS CO., LTD., Seoul (KR); Seoul National University Industry Foundation, Seoul (KR)

(21) Appl. No.: 11/011,108

(22) Filed: Dec. 15, 2004

(30) Foreign Application Priority Data
Sep. 1, 2004 (KR) 10-2004-0069655

(51) Int. Cl. H01M 8/04; B60L 11/18

(52) U.S. Cl. 429/23; 180/65.3

(57) ABSTRACT

A series type air supply system for fuel cell-powered vehicles wherein a low speed air supplier and a high speed air supplier are connected in a series for performance of a multi-staged pressurization to variably operate the air suppliers of high efficiency according to an output value of a fuel cell stack and to improve the work efficiency of a fuel cell system under all driving modes of fuel cell-powered vehicles. Air is pressurized by a 2-staged compression of the low and high speed air suppliers under an accelerated driving mode to reduce the work load of compression and to increase the overall efficiency of the fuel cell system.

### CROSS-REFERENCE TO RELATED APPLICATIONS

The present application is based on, and claims priority from, Korean Application Serial Number 10-2004-0069655, filed on Sep. 1, 2004, the disclosure of which is hereby incorporated by reference herein in its entirety.

### FIELD OF THE INVENTION

The present invention relates to a series type air supply system for fuel cell-powered vehicles. More particularly, the present invention relates to a series type air supply system for fuel cell-powered vehicles constructed to connect in a series a low speed air supplier and a high speed air supplier for performance of a multi-staged pressurization, enabling to improve a work efficiency of a fuel cell system and variably transfer the air suppliers according to output ranges of a fuel cell stack.

### BACKGROUND OF THE INVENTION

A fuel cell stack in which a plurality of poly electrolyte fuel cell units are laminated receives hydrogen and oxygen gas from the outside to generate the electric energy via electrochemical reaction. The fuel cell stack therefore needs an apparatus for supplying air thereto from the outside.

An apparatus supplying air to a fuel cell stack is called an air supplier. The air supplier, an apparatus where the bulk of energy is spent in the operation of a fuel cell system, uses 5-20% of maximum output range of the fuel cell system.

An air blower or an air compressor operated by a motor may be used to supply air for fuel cell-powered vehicles mounted with a fuel cell stack. There are mechanical drawbacks in these apparatus in that efficiency is high only in certain output ranges, and efficiency is very low in most of the remaining output ranges.

In case of a vehicle mounted with a poly electrolyte fuel cell stack of 80-90 KW output, an output range of 0-5 KW in a fuel cell stack is needed for starting, decelerating or stopping a vehicle, and an output range of 10-15 KW is necessary for constant speed driving mode, the other high-energy consuming modes such as accelerating mode and grade mode need an output range of 20-90 KW in a fuel cell stack.

As a result, maximum efficiency of the fuel cell system equipped with one air supplier can be realized only in certain broad output ranges in the fuel cell stack. However, a very low efficiency is realized in most of the output ranges.

There is another drawback in that the durability of respective parts including the air supplier deteriorates over time.

### SUMMARY OF THE INVENTION

Embodiments of the present invention are provided with a series type air supply system for fuel cell-powered vehicles configured to connect a low speed air supplier and a high speed air supplier in a series for performance of multi-staged pressurization, thus enabling to improve the overall work efficiency of a fuel cell system.

The present invention is further provided with a series type air supply system for fuel cell-powered vehicles configured to connect a low speed air supplier of high efficiency (having an output range of 0-15 KW in a fuel cell stack) and a high speed air supplier of high efficiency (having an output range of 15-90 KW in the fuel cell stack) in a series, whereby the air suppliers can be variably and switchably operated according to the driving conditions of vehicles to optimally operate the air supply system.

In accordance with a first embodiment of the present invention, the series type air supply system for fuel cell-powered vehicles comprises an air passage connecting an air filter and a fuel cell stack. A low speed air supplier is mounted at an inlet side of the air passage. A high speed air supplier is installed at an outlet side of the air passage.

In accordance with a second embodiment of the present invention, the series type air supply system for fuel cell-powered vehicles comprises an air passage connecting an air filter and a fuel cell stack. A low speed air supplier is mounted at an inlet side of the air passage. A high speed air supplier is installed at an outlet side of the air passage. Output detecting means measures an output value of the fuel cell stack. A controller controls a switch between the low speed air supplier and the high speed air supplier according to an output value measured by the output detecting means.

As a result, the controller gradually stops the operation of the low speed air supplier at 14 KW when the output of the fuel cell stack is increased and gradually increases the operation of the high speed air supplier such that the air supplier can be completely switched from a low speed to a high speed at 16 KW. When the output of the fuel cell stack is decreased, the operation of the high speed air supplier gradually stops at 16 KW and the operation of the low speed air supplier is gradually increased, thus completely switching the air supplier from high speed to low speed at 14 KW.

According to a third embodiment of the present invention, the series type air supply system for fuel cell-powered vehicles comprises an air passage connecting an air filter and a fuel cell stack. A low speed air supplier is mounted at an inlet side of the air passage. A high speed air supplier is mounted at an outlet side of the air passage. Output detecting means measures an output value of the fuel cell stack. A controller controls a switch between the low speed air supplier and the high speed air supplier according to an output value measured by the output detecting means. A bypass pipe is mounted at a lateral surface of the air passage via front and rear portions of the high speed air supplier.

### BRIEF DESCRIPTION OF THE DRAWINGS

For a better understanding of the nature and objects of the present invention, reference should be made to the following detailed description with the accompanying drawings, in which:

FIG. 1 is a schematic block diagram for illustrating a series type air supply system for fuel cell-powered vehicles according to a first embodiment of the present invention;

FIG. 2 is a schematic block diagram for illustrating a series type air supply system for fuel cell-powered vehicles according to a second embodiment of the present invention;

FIG. 3 is a schematic block diagram for illustrating a series type air supply system for fuel cell-powered vehicles according to a third embodiment of the present invention; and

FIG. 4 is a schematic drawing for explaining an increase of efficiency according to the present invention.

### DETAILED DESCRIPTION OF THE PREFERRED EMBODIMENTS

The preferred embodiment of the present invention will now be described in detail with reference to the annexed drawings, where the present embodiment is not limiting the scope of the present invention but is given only as an illustrative purpose.

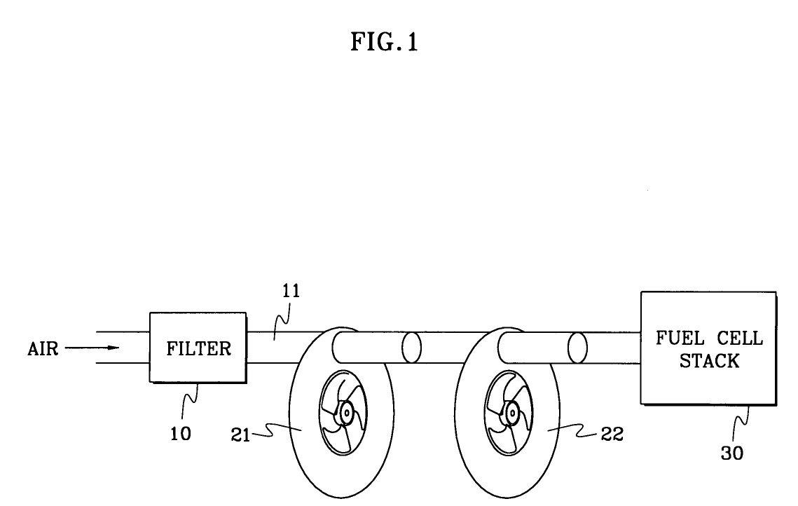

As shown in FIG. 1, the series type air supply system for fuel cell-powered vehicles according to a first embodiment of the present invention includes an air passage 11 connecting an air filter 10 and a fuel cell stack 30. A low speed air supplier 21 is mounted at an inlet side of the air passage 11. A high speed air supplier 22 is positioned at an outlet side of the air passage 11.

The air passage 11 is a tubular passage for supplying to the fuel cell stack 30 the air that has passed the air filter 10 for filtering dust and the like induced from the outside.

The low speed air supplier 21 is an air supplier having a high efficiency at an output range of 0-15 KW in the fuel cell stack 30, and the high speed air supply 22 has a high efficiency at an output range of 15-90 KW in the fuel cell stack 30.

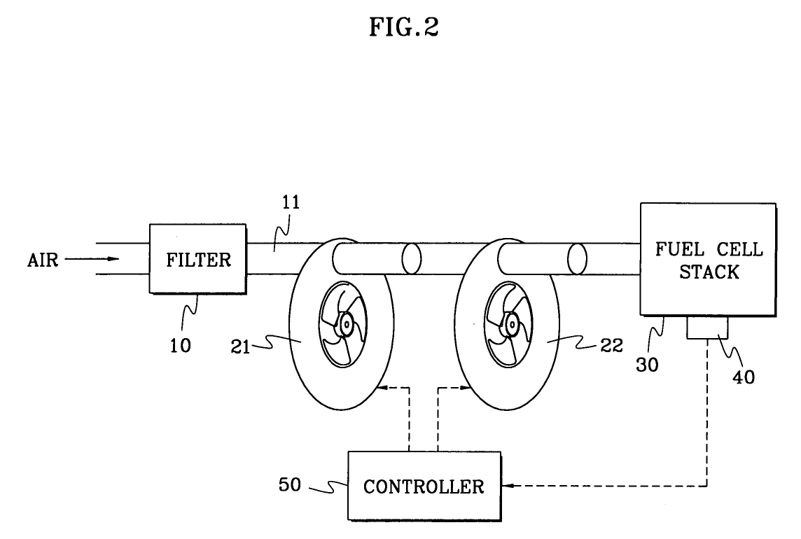

As illustrated in FIG. 2, the series type air supply for fuel cell-powered vehicles according to the second embodiment of the present invention includes an air passage 11 connecting an air filter 10 and a fuel cell stack 30. A low speed air supplier 21 is mounted at an inlet side of the air passage 11. A high speed air supplier 22 is installed at an outlet side of the air passage 11.

Output detecting means 40 measures an output value of the fuel cell stack 30. A controller 50 controls an operational switch between the low speed air supplier 21 and the high speed air supplier 22 according to an output value measured by the output detecting means 40.

The output detecting means 40, which is a wattmeter or a voltage meter, measures an output amount of the fuel cell stack 30 to output same to the controller 50.

The controller 50 controls the ON/OFF operation of the low speed air supplier 21 or the high speed air supplier 22 according to the output ranges of the fuel cell stack 30 input from the output detecting means 40.

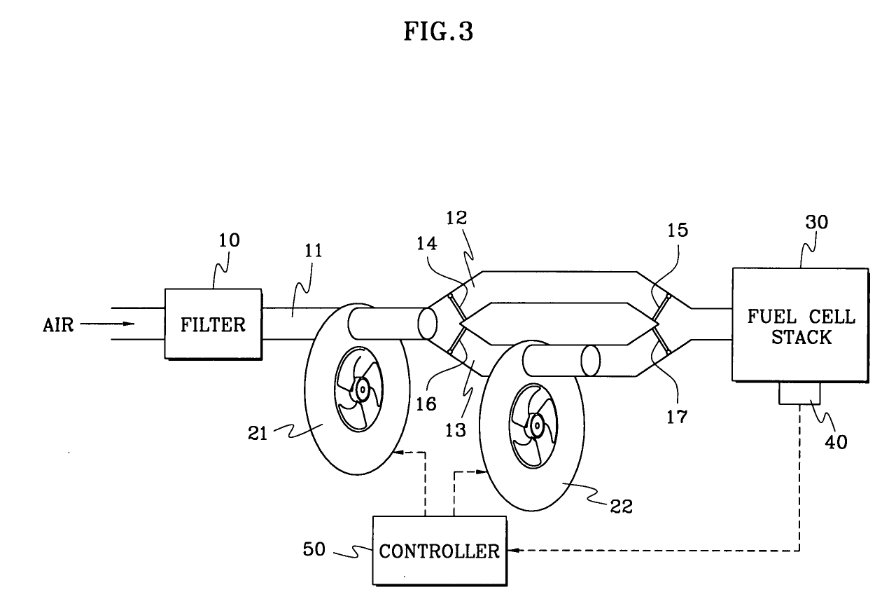

As illustrated in FIG. 3, in addition to the construction specified in the second embodiment of the present invention, the series type air supply for fuel cell-powered vehicles according to the third embodiment of the present invention further comprises a bypass pipe 12 mounted at a lateral surface of a main air passage 13 and connected before and after the high speed air supplier 22, openness control valves 14,15 respectively mounted at an inlet and an outlet of the bypass pipe 12, and openness control valves 16,17 mounted at an inlet and an outlet of the main air passage 13 where the high speed air supplier 22 is installed.

The controller 50 controls the ON/OFF operation of the low speed air supplier 21 or the high speed air supplier 22 according to the output ranges of the fuel cell stack 30 inputted from the output detecting means 40, and simultaneously controls the openness of the openness control valves 14, 15, 16, 17 respectively mounted at the inlet and outlet of the bypass pipe 12 and the main air passage 13.

Hereinafter, the operation of the present invention thus constructed will be described in detail with reference to the annexed FIGS. 1-4.

An air supplier, where the bulk of energy is spent in the operation of a fuel cell system, is divided into a low speed air supplier 21 having a maximum efficiency at below 15 KW, and a high speed air supplier 22 having a maximum efficiency at 15 KW or above.

In the first embodiment of the present invention, when a vehicle mounted with the fuel cell stack 30 is moving under a decelerated mode at an output range of within 15 KW, only the low speed air supplier 21 is activated and the high speed air supplier 22 is deactivated. When the vehicle is gradually accelerated to raise the output of the fuel cell stack at 15 KW or above, both the low and high speed air suppliers 21,22 are activated to improve the work efficiency by way of multi-staged pressurization.

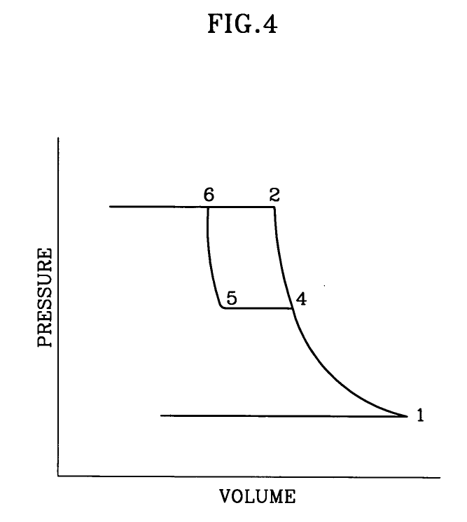

A more specific explanation will be given with reference to FIG. 4. When air is pressurized using only one air supplier, work is performed along the line of 1-4-2-6. When two air suppliers are used for pressurization of air, work is performed along the line of 1-4-5-6 such that a work load of as much as 2-4-5-6 can be reduced in the volume-pressure curve.

The second embodiment of the present invention has a feature in that transfer of the low speed air supplier 21 and the high speed air supplier 22 are accurately controlled in order to prevent deficiency of air supplied to the fuel cell stack caused by sudden a stop and drive in the course of transfer between the low speed air supplier 21 and the high speed air supplier 22.

In particular, the output detecting means 40 mounted at the fuel cell stack 30 measures an output value generated by the fuel cell stack 30 to transmit same to the controller 50.

As a result, the controller 50 gradually stops the operation of the low speed air supplier 21 at 14 KW when the output of the fuel cell stack 30 is increased, and gradually increases the operation of the high speed air supplier 22, enabling the air supplier to be completely transferred from low speed to high speed at 16 KW. When the output of the fuel cell stack 30 is decreased, the operation of the high speed air supplier 22 is gradually stopped at 16 KW and operation of the low speed air supplier 21 is gradually increased, enabling the air supplier to be completely and controllably transferred from high speed to low speed at 14 KW.

In the third embodiment of the present invention, when only the low speed air supplier 21 is operated and the high speed air supplier 22 is stopped, the bypass pipe 12 is connected at the lateral surface of the main air passage 13 via front and rear portions of the high speed air supplier 22, and the inlet and outlet of the bypass pipe 12 and the inlet and outlet of the main air passage 13 mounted with the high speed air supplier 22 are respectively installed with openness control valves.

As a result, when only the low speed air supplier 21 is operated because of the output of the fuel cell stack 30 at below 15 KW, the openness control valve 16 at the mouth of the main air passage 13 is closed, and the openness control valve 14 at the inlet of the bypass pipe 12 and openness control valve 15 at the outlet are opened, allowing the air compressed by the low speed air supplier 21 to be smoothly supplied to the fuel cell stack 30.

If necessary, the openness control valve 17 at the outlet of the main air passage 13 may be closed to prevent the air supplied via the bypass pipe 12 from flowing backward to thereby flow toward the high speed air supplier 22.

In case the output of the fuel cell stack 30 is over 15 KW, the openness control valve 14 at the inlet of the bypass pipe 12 is closed and the openness control valve 16 at the mouth of the main air passage 13 is opened, and simultaneously the low and high speed air suppliers 21, 22 are operated to allow the air to be compressed by a multi-staged manner so that the work efficiency of the fuel cell system can be increased.

The foregoing description of the preferred embodiments of the present invention has been presented for the purpose of illustration and description. It is not intended to be exhaustive or to limit the invention to the precise form disclosed, and modifications and variations are possible in light of the above teachings or may be acquired from practice of the invention. It is intended that the scope of the invention be defined by the claims appended hereto, and their equivalents.

As apparent from the foregoing, there is an advantage in the series type air supply system for fuel cell-powered vehicles thus described according to the embodiments of the present invention in that an air supply system of high efficiency can be variably operated according to an output value of a fuel cell stack, enabling to operate the fuel cell system in an efficient manner at all driving modes of fuel cell-powered vehicles.

Particularly, air is pressurized by 2-stage compression of low and high speed air suppliers under an accelerated running mode to enable to reduce the work load of compression and to increase the total efficiency of the fuel cell system.

There is another advantage in that a bypass pipe is installed at a lateral surface of a main air passage to prevent a high speed air supplier mounted at an outlet side of an air passage from acting as an obstacle to air movement during a decelerated driving mode where only the low speed air supplier is operated.

1. A series type air supply system for fuel cell-powered vehicles, comprising:
an air passage connecting an air filter to a fuel cell stack;
a low speed air supplier mounted on a side of an inlet of the air passage;
a high speed air supplier mounted on a side of an outlet of the air passage;
an output detector measuring an output value of the fuel cell stack; and
a controller controlling a switch between the low speed air supplier and the high speed air supplier according to an output value measured by the output detector.

2. The system as defined in claim 1, wherein the controller gradually stops the operation of the low speed air supplier at 14 KW when the output of the fuel cell stack is increased, and gradually increases the operation of the high speed air supplier, enabling the air supplier to be completely transferred from low speed to high speed at 16 KW, and when the output of the fuel cell stack is decreased, the operation of the high speed air supplier is gradually stopped at 16 KW and the operation of the low speed air supplier is gradually increased, enabling the air supplier to be completely and controllably transferred from high speed to low speed.

3. The system as defined in claim 1, the system further comprising a bypass pipe mounted at a lateral surface of the air passage via front and rear portions of the high speed air supplier.

4. The system as defined in claim 3, wherein openness control valves are respectively mounted at the inlet and outlet of the bypass pipe.

5. The system as defined in claim 3, wherein openness control valves are respectively mounted at front and rear portions of the high speed air supplier.
